(19) United States
(12) Patent Application Publication
(10) Pub. No.: US 2007/0153161 A1
(43) Pub. Date: Jul. 5, 2007

(54) METHOD FOR MANUFACTURING POLARIZER

(75) Inventor: GA-LANE CHEN, Santa Clara, CA (US)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., Taipei Hsien (TW)

(21) Appl. No.: 11/309,649

(22) Filed: Sep. 5, 2006

(30) Foreign Application Priority Data
Dec. 30, 2005 (CN) 200510121399.X

(51) Int. Cl. G02F 1/1335

(52) U.S. Cl. 349/96

(57) ABSTRACT

A method for manufacturing a polarizer includes the steps of: providing an optically anisotropic transparent substrate; defining a plurality of anisotropically shaped grooves in at least one surface of the substrate, the anisotropically shaped grooves being oriented in a same direction; and applying a layer of optically anisotropic transparent material on the at least one surface of the substrate thereby forming a plurality of elongated particles in and aligned with the anisotropically shaped grooves, the elongated particles being configured for inducing shape anisotropy in the substrate.

### FIELD OF THE INVENTION

The present invention generally relates to methods for manufacturing optical elements, and especially to a method for manufacturing polarizers used in liquid crystal displays (LCDs).

### DESCRIPTION OF RELATED ART

Although most portable electronic devices such as laptop and notebook computers, mobile phones and game devices have viewing screens unlike cathode-ray-tube (CRT) monitors of conventional desktop computers, users generally expect the viewing screens to provide performance equal to that of CRT monitors. To meet this demand, computer manufacturers have sought to build flat panel displays (FPDs) offering superior resolution, color and contrast, while at the same time requiring minimal power consumption. LCDs are one type of FPD which satisfy these expectations. However, liquid crystals used in LCDs are not self-luminescent. Rather, LCDs generally need a surface emitting device such as a backlight module which can offer sufficient luminance (brightness) in a wide variety of ambient light environments. However, light beams incident on the liquid crystals layer of the LCD must be polarized light beams because of characteristics of the liquid crystal cells. Therefore, polarizers are used in the LCD.

Un-polarized light beams emitted from the backlight module are transmitted to the polarizers including a lower polarizer and a upper polarizer. The lower polarizer absorbs a first polarized component of the light beams, and transmits a second orthogonally polarized component of the light beams. The second orthogonally polarized component is transmitted to the liquid crystal cell. Thus, approximately 50% of the light beams emitted by the backlight module are lost before reaching the liquid crystal cell. The second orthogonally polarized component passes through other LCD elements such as, a TFT substrate, the liquid crystal layer, and a color filter, with a result that generally no more than 20% of the light beams emitted from the backlight module is seen by the user. That is, utilization ratio of the light beams is low.

What is needed, therefore, is a method for manufacturing polarizers with a high light beam utilization ratio.

### SUMMARY OF THE INVENTION

A method for manufacturing a polarizer according to a preferred embodiment includes the steps of: providing an optically anisotropic transparent substrate; defining a plurality of anisotropically shaped grooves in at least one surface of the substrate, the anisotropically shaped grooves being oriented in a same direction; and applying a layer of optically anisotropic transparent material on the at least one surface of the substrate thereby forming a plurality of elongated particles in and aligned with the anisotropically shaped grooves, the elongated particles being configured (i.e., structured and arranged) for inducing shape anisotropy in the substrate.

Advantages and novel features will become more apparent from the following detailed description of the present method, when taken in conjunction with the accompanying drawings.

### BRIEF DESCRIPTION OF THE DRAWINGS

Many aspects of the present method can be better understood with reference to the following drawings. The components in the drawings are not necessarily drawn to scale, the emphasis instead being placed upon clearly illustrating the principles of the present method. Moreover, in the drawings, like reference numerals designate corresponding parts throughout the several views.

FIG. 1 is a flow chart of a method for manufacturing a polarizer in accordance with a preferred embodiment; and

FIG. 2 is a schematic view of a liquid crystal display having a polarizer provided by the method shown in FIG. 1.

Corresponding reference characters indicate corresponding parts throughout the drawings. The exemplifications set out herein illustrate at least one preferred embodiment of the present method, in one form, and such exemplifications are not to be construed as limiting the scope of the invention in any manner.

### DETAILED DESCRIPTION OF THE INVENTION

References will now be made to the drawings to describe preferred embodiments of the present method, in detail.

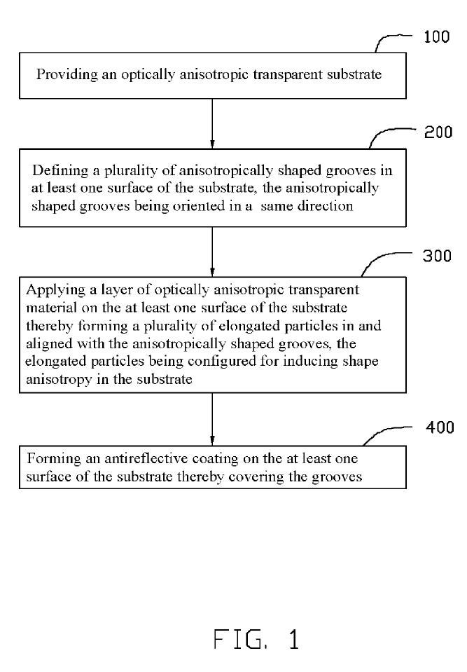

Referring to FIG. 1, a method for manufacturing a polarizer according to a preferred embodiment is shown. The method includes the steps of:
(100) providing an optically anisotropic transparent substrate;
(200) defining a plurality of anisotropically shaped grooves in at least one surface of the substrate, the anisotropically shaped grooves being oriented in a same direction;
(300) applying a layer of optically anisotropic transparent material on the at least one surface of the substrate thereby forming a plurality of elongated particles in and aligned with the anisotropically shaped grooves, the elongated particles being configured (i.e., structured and arranged) for inducing shape anisotropy in the substrate.
(400) forming an antireflective coating on the at least one surface of the substrate thereby covering the grooves.

In step (100), the transparent substrate at least allows visible light (i.e., with a wavelength from 390 to 760 nanometers) to pass therethrough. A thickness of the transparent substrate is in a range from 1 to 10 millimeters, preferably 2 to 5 millimeters. In the preferable embodiment, a material of the transparent substrate is calcite. The calcite allows a light with a wavelength from 350 to 2300 nanometers to pass therethrough. Alternatively, the material of the transparent substrate may be chosen from the group consisting of silicon dioxide (SiO2), aluminum oxide (Al2O3), and yttrium vanadate crystal (YVO4).

In step (200), each groove is substantially elliptically-shaped and oriented in a same direction. A depth of each groove is in a range from 2 to 100 microns, preferably 5 to 50 microns. A length of a minor axis of the elliptical-shaped groove is shorter than a wavelength of an incident light, preferably half shorter than a wavelength of incident light. If the incident light is natural light, the wavelength of the incident light is a central wavelength of the natural light. A length of a major axis of the elliptically-shaped groove is equal to or longer than the wavelength of the incident light, preferably approximately two times longer than the wavelength of the incident light. An aligned direction of the major axes of the grooves is along a same direction parallel to the surface of the transparent substrate. An aspect ratio of the elliptically-shaped groove is in a range from 2 to 100, and is preferably 5 to 20. The aspect ratio is a ratio of a length of the major axis to that of the minor axis of the groove. A laser treatment process may be used to define the plurality of grooves on the surface of the transparent substrate.

In step (300), the layer of optically anisotropic transparent material is formed on the at least one surface of the substrate. The plurality of elongated particles are in and aligned with the anisotropically shaped grooves, and configured for inducing shape anisotropy in the substrate. The layer of optically anisotropic transparent material is selected from the group consisting of tin indium oxide, silicon dioxide, aluminum oxide, calcite and yttrium vanadate crystal.

In step (400), the antireflective coating allows a visible light to pass therethrough. The antireflective coating includes first titanium dioxide coating with a thickness of 10 to 16 nanometers formed on the at least one surface of the substrate, a first silicon dioxide coating with a thickness of 26 to 32 nanometers formed on the first titanium dioxide coating, a second titanium dioxide coating with a thickness of 80 to 120 nanometers formed on the first silicon dioxide coating, and a second silicon dioxide coating with a thickness of 78 to 86 nanometers formed on the second titanium dioxide coating. Interference between multiple coats of the antireflective coating can decrease a reflective ration of an incident light so as to create an antireflection effect.

The coating step may be a vacuum coating process. The vacuum coating process is selected from the group consisting of electron-beam evaporation, ion-beam evaporation, magnetron sputtering deposition with shadow angle, electron spin resonance deposition, and microwave frequency enhanced deposition, etc.

The method for manufacturing a polarizer according to the preferred embodiment is easily to operate and low-cost. The polarizer is with a plurality of grooves on the surface of the substrate and a plurality of elongated particles for inducing shape anisotropy in the substrate.

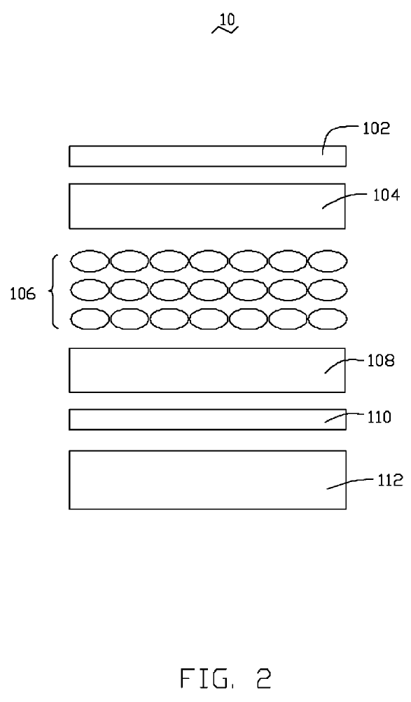

Referring to FIG. 2, a liquid crystal display 10 employing the polarizer made by the method of the preferred embodiment is shown. The liquid crystal display 10 includes an upper substrate 104, a lower substrate 108 opposite to the upper substrate 104, a liquid crystals layer 106 sandwiched between the upper substrate 104 and the lower substrate 108, an upper polarizer 102, a lower polarizer 110, and a backlight module 112. The upper polarizer 102 and the lower polarizer 110 are manufactured by the method according to the preferred embodiment, and disposed outside the upper substrate 104 and the lower substrate 108 respectively. Light beams emitted from the backlight module 112 can be considered to be natural light beams including two linearly polarized non-coherent light beams perpendicular to each other. Due to shape anisotropy of the lower polarizer 110, the light beams incident to the surface of the lower polarizer 110 with the plurality of grooves are separated perpendicularly to become linearly polarized light beams. Moreover a transmission ratio of each polarizer is about 70%. Therefore, the light beam utilization ratio is high.

It is to be understood that the above-described embodiment is intended to illustrate rather than limit the invention. Variations may be made to the embodiment without departing from the spirit of the invention as claimed. The above-described embodiments are intended to illustrate the scope of the invention and not restrict the scope of the invention.

What is claimed is:

1. A method for manufacturing a polarizer, the method comprising the steps of:
providing an optically anisotropic transparent substrate;
defining a plurality of anisotropically shaped grooves in at least one surface of the substrate, the anisotropically shaped grooves being oriented in a same direction; and
applying a layer of optically anisotropic transparent material on the at least one surface of the substrate thereby forming a plurality of elongated particles in and aligned with the anisotropically shaped grooves, the elongated particles being configured for inducing shape anisotropy in the substrate.

2. The method as claimed in claim 1, wherein the substrate is comprised of a material selected from the group consisting of calcite, silicon dioxide, aluminum oxide, and yttrium vanadate crystal.

3. The method as claimed in claim 1, wherein a thickness of the substrate is in a range from 1 to 10 millimeters.

4. The method as claimed in claim 1, wherein each groove is substantially elliptically shaped.

5. The method as claimed in claim 1, wherein a depth of each groove is in a range from 2 to 10 microns.

6. The method as claimed in claim 4, wherein an aspect ratio of each groove is in a range from 2 to 100.

7. The method as claimed in claim 1, wherein the plurality of anisotropically shaped grooves is defined in the at least one surface of the substrate using a laser treatment process.

8. The method as claimed in claim 1, further comprising a step of forming an antireflective coating on the at least one surface of the substrate thereby covering the layer of optically anisotropic transparent material.

9. The method as claimed in claim 8, wherein the antireflective coating comprises a first titanium dioxide coating with a thickness of 10 to 16 nanometers formed on the at least one surface of the substrate, a first silicon dioxide coating with a thickness of 26 to 32 nanometers formed on the first titanium dioxide coating, a second titanium dioxide coating with a thickness of 80 to 120 nanometers formed on the first silicon dioxide coating, and a second silicon dioxide coating with a thickness of 78 to 86 nanometers formed on the second titanium dioxide coating.

10. The method as claimed in claim 8, wherein the antireflective coating is formed by a method selected from the group consisting of electron-beam evaporation, ion-beam evaporation, magnetron sputtering deposition with shadow angle, electron spin resonance deposition, and microwave frequency enhanced deposition.

11. The method as claimed in claim 1, wherein the layer of optically anisotropic transparent material is selected from the group consisting of tin indium oxide, silicon dioxide, aluminum oxide, calcite and yttrium vanadate crystal.
